(19) United States
(12) Patent Application Publication
(10) Pub. No.: US 2025/0306431 A1
(43) Pub. Date: Oct. 2, 2025

(54) GIANT SECOND HARMONIC GENERATION IN BULK MONOLAYER MOS2 THIN FILMS

(71) Applicant: The Regents of the University of California, Oakland, CA (US)

(72) Inventors: Xiangfeng DUAN, Los Angeles, CA (US); Yu HUANG, Los Angeles, CA (US); Boxuan ZHOU, Los Angeles, CA (US)

(73) Assignee: The Regents of the University of California, Oakland, CA (US)

(21) Appl. No.: 19/094,643

(22) Filed: Mar. 28, 2025

Related U.S. Application Data
(60) Provisional application No. 63/572,132, filed on Mar. 29, 2024.

(51) Int. Cl. G02F 1/37; G02F 1/35; G02F 1/355

(52) U.S. Cl. CPC G02F 1/37; G02F 1/3542; G02F 1/3551

(57) ABSTRACT

The present disclosure relates to a scalable bulk monolayer MoS₂ (BM-MoS₂) thin film for highly efficient SHG. The solution-assembled centimeter-scale BM-MoS₂ thin films consist of alternating monolayer MoS₂ atomic crystals and organic molecular layers that prevent interlayer coupling, thus preserving monolayer-like physical properties while achieving significantly increased optical cross-sections. The SHG studies demonstrate that the BM-MoS₂ exhibits a giant SHG that is 126 times higher than monolayer MoS₂ and 21 times higher than the single crystalline GaAs wafer, a material with the highest second-order NLO susceptibility among known bulk semiconductors. The facile assembly of BM-MoS₂ thin films with highly efficient SHG offers a scalable pathway for developing ultrathin, efficient, and cost-effective NLO devices.

### CROSS-REFERENCE TO RELATED APPLICATIONS

The present application claims priority to U.S. Provisional Patent Application No. 63/572,132 filed Mar. 29, 2024, the contents of which are incorporated herein by reference in their entirety.

### STATEMENT OF GOVERNMENT SPONSORED RESEARCH

This invention was made with government support under N00014-22-1-2631 awarded by the U.S. Navy, Office of Naval Research. The government has certain rights in the invention.

### TECHNICAL FIELD

The present embodiments relate generally to thin film materials, and more particularly thin film materials for highly efficient second harmonic generation.

### BACKGROUND

Second harmonic generation (SHG) is a physical process in which two photons interact with a noncentrosymmetric optical material, generating a double-frequency photon. As a prototypical nonlinear optical (NLO) process, SHG plays an essential role in various applications, including frequency conversion, optical microscopy, and material surface characterizations. The advancement of SHG technologies depends on discovering and fabricating noncentrosymmetric materials with large second-order NLO susceptibility. Monolayer molybdenum disulfide (MoS₂) features exceptional SHG due to its inherent noncentrosymmetry and large X⁽²⁾, making it highly promising for nonlinear optical sources. It has been suggested that monolayer MoS₂ could exhibit an enormous X⁽²⁾ up to 100-1000 pm/V. This places it on par with the highest X⁽²⁾ reported in traditional 3D semiconductors such as GaAs (with X⁽²⁾˜700 pm/V) and significantly surpasses the X⁽²⁾ values of other common SHG materials, such as beta-barium borate (BBO, X⁽²⁾˜4.4 pm/V). However, being atomically thin limits its ultimate efficiency in nonlinear frequency conversion due to insufficient light-matter interaction distance. While the naturally existing 2H-phase MoS₂ bulk crystal possesses the Bernal stacking order, which restores the centrosymmetry and prohibits SHG.

It is against this technological backdrop that a technological solution to these and other problems rooted in this technology was sought.

### SUMMARY

The present embodiments relate generally to a solution-processible MoS₂ thin film material for highly efficient SHG that consists of alternating monolayer MoS₂ atomic crystals and organic molecular layers. The organic interlayer spacers effectively isolate the interlayer coupling of MoS₂, thus preserving monolayer-like NLO properties while achieving significantly increased optical cross-sections in the resulting thin film, which can be referred as “bulk monolayer” MoS₂ (BM-MoS₂).

In one example method according to embodiments, monolayer MoS₂ ink was first prepared using an exfoliation and separation process and dispersed in isopropanol (IPA) to formulate a stable and easy-to-handle ink after binding with organic ligands (PVP). The monolayer MoS₂ ink was then assembled onto a selected substrate to form a large-area continuous BM-MoS₂ thin film, where the PVP-capped MoS₂ monolayers were stacked vertically to form a MoS₂/PVP superlattice thin film. SHG studies revealed that the BM-MoS₂ with ˜30 nm film thickness features a giant SHG efficiency enhancement of up to 126 and 21 times of the monolayer MoS₂ and the benchmark single crystalline GaAs wafers.

Among many advantages, the present embodiments can address unmet needs in the market such as the following:
1) Scalable thin-film synthesis: The development of scalable synthesis methods for bulk monolayer materials addresses the critical challenge in scalable fabrication of atomically thin 2D materials. The solution-processible thin film with tunable thickness can be rapidly produced at large scale using diverse techniques such as spin-coating, spray-coating, blade coating, and inkjet-printing.
2) Giant enhancement of SHG efficiency: Remarkably, the SHG of a ˜30 nm thick bulk monolayer film showed a 126 times enhancement when compared with that of the monolayer MoS₂, and an essentially infinite enhancement when compared to the pristine bulk 2H-phase MoS₂ that showed negligible SHG signal below the detection limit. Moreover, the SHG intensity of the bulk monolayer thin film was 21 times stronger than that of the single crystal GaAs wafer, which is a well-characterized benchmark material with the largest SH susceptibilities (X₁₄⁽²⁾˜700 pm/V) reported for known semiconductors.
3) Facile integration: BM-MoS₂ permits facile and versatile integration with diverse photonic platforms, such as 2D photonic crystals, resonators, meta-surfaces, lens, and fibers, which could open up a wide array of possibilities in the field of optics and surpass the capabilities of conventional bulk materials.
4) Excellent stability: The encapsulation of MoS₂ 2D layers with organic spacers slow down the diffusion and adsorption of moisture and oxygen, contributing to the enhanced stability of bulk monolayer material. The SHG signal from a BM-MoS₂ thin film remained stable in ambient conditions under high power laser pumping for more than 20 minutes (˜3×10⁴ W/cm², 780 nm laser). Moreover, the SHG only dropped by 30% even after baking at 370° C. compared to a fresh, non-annealed sample.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects and features of the present embodiments will become apparent to those ordinarily skilled in the art upon review of the following description of specific embodiments in conjunction with the accompanying figures, wherein:

FIGS. 1A to 1C illustrate aspects of example embodiments of bulk monolayer MoS₂ thin film structure and second harmonic generation (SHG).

FIGS. 2A to 2G illustrate aspects of example embodiments of preparation and characterizations of the BM-MoS₂ thin films

FIGS. 3A to 3C illustrate example aspects of SHG characterizations according to embodiments.

FIGS. 4A to 4F illustrate example aspects of thickness-dependent SHG and electromagnetic modeling according to embodiments.

FIGS. 5A and 5B are graphs illustrating additional example aspects of embodiments.

FIGS. 6A and 6B are graphs illustrating additional example aspects of embodiments.

FIG. 7 illustrates aspects of an example MoS₂ thin film structure of embodiments.

FIG. 8 illustrates example optical properties of embodiments.

FIG. 9 illustrates additional example optical properties of embodiments.

FIGS. 10A and 10B illustrate additional example optical properties of embodiments.

The patent or application file contains at least one drawing executed in color. Copies of this patent or patent application publication with color drawing(s) will be provided by the Office upon request and payment of necessary fee.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

Second harmonic generation (SHG) is a nonlinear optical process in which two photons interact with a noncentrosymmetric material, generating a double-frequency photon (Boyd, R. W.; Gaeta, A. L.; Giese, E., Nonlinear optics. In Springer Handbook of Atomic, Molecular, and Optical Physics, Springer: 2008; pp 1097-1110). As a prototypical nonlinear optical (NLO) process, the SHG plays an essential role in various applications, including frequency conversion (Keller, U., Recent developments in compact ultrafast lasers. Nature 2003, 424, 831-8), optical microscopy (Zipfel, W. R.; Williams, R. M.; Webb, W. W., Nonlinear magic: multiphoton microscopy in the biosciences. Nature biotechnology 2003, 21, 1369-1377), and material surface characterizations (Shen, Y., Surface properties probed by second-harmonic and sum-frequency generation. Nature 1989, 337, 519-525). The advancement of SHG technologies depends on discovering and fabricating noncentrosymmetric materials with large second-order NLO susceptibility X⁽²⁾. Nevertheless, traditional NLO materials based on bulk three-dimensional (3D) crystals are often plagued by relatively low NLO susceptibility, or difficulties for heterogeneous on-chip integration, which become especially pertinent for miniaturized on-chip photonic devices (Autere, A.; Jussila, H.; Dai, Y.; Wang, Y.; Lipsanen, H.; Sun, Z., Nonlinear Optics with 2D Layered Materials. Advanced Materials 2018, 30, 1705963).

Two-dimensional (2D) transition metal dichalcogenides (TMDs), such as monolayer MoS₂, have been recently suggested as a new class of highly promising NLO materials for their exceptionally large X⁽²⁾ and easy processability for hybrid integration (Wen, X.; Gong, Z.; Li, D., Nonlinear optics of two-dimensional transition metal dichalcogenides. InfoMat 2019, 1, 317-337; Chen, J. H.; Tan, J.; Wu, G. X.; Zhang, X. J.; Xu, F.; Lu, Y. Q., Tunable and enhanced light emission in hybrid WS2-optical-fiber-nanowire structures. Light, Sci. & Applic. 2019, 8, 8; Chen, H.; Corboliou, V.; Solntsev, A. S.; Choi, D. Y.; Vincenti, M. A.; de Ceglia, D.; de Angelis, C.; Lu, Y.; Neshev, D. N., Enhanced second-harmonic generation from two-dimensional MoSe2 on a silicon waveguide. Light, Sci & Applic. 2017, 6 (10), c17060; Säynätjoki, A.; Karvonen, L.; Rostami, H.; Autere, A.; Mehravar, S.; Lombardo, A.; Norwood, R. A.; Hasan, T.; Peyghambarian, N.; Lipsanen, H.; Kicu, K.; Ferrari, A. C.; Polini, M.; Sun, Z., Ultra-strong nonlinear optical processes and trigonal warping in MoS₂ layers. Nature Communications 2017, 8, 893; Zuo, Y.; Yu, W.; Liu, C.; Cheng, X.; Qiao, R.; Liang, J.; Zhou, X.; Wang, J.; Wu, M.; Zhao, Y.; Gao, P.; Wu, S.; Sun, Z.; Liu, K.; Bai, X.; Liu, Z., Optical fibres with embedded two-dimensional materials for ultrahigh nonlinearity. Nature Nanotechnology 2020, 15, 987-991; Wang, Y.; Xiao, J.; Chung, T.-F.; Nie, Z.; Yang, S.; Zhang, X., Direct electrical modulation of second-order optical susceptibility via phase transitions. Nature Electronics 2021, 4, 725-730).

For example, monolayer MoS₂ features a X⁽²⁾ in the range of 100-1000 pm/V (Clark, D. J.; Senthilkumar, V.; Le, C. T.; Wecrawarne, D. L.; Shim, B.; Jang, J. I.; Shim, J. H.; Cho, J.; Sim, Y.; Scong, M. J.; Rhim, S. H.; Freeman, A. J.; Chung, K. H.; Kim, Y. S., Strong optical nonlinearity of CVD-grown MoS₂ monolayer as probed by wavelength-dependent second-harmonic generation. Physical Review B 2014, 90, 121409; Bredillet, K.; Riporto, J.; Forcherio, G. T.; Dunklin, J. R.; Wolf, J.-P.; Bonacina, L.; Mugnier, Y.; Le Dantec, R., Dispersion of the nonlinear susceptibility of MoS₂ and WS2 from second-harmonic scattering spectroscopy. Physical Review B 2020, 102, 235408), which is comparable to the highest X⁽²⁾ ever reported in traditional semiconductors like GaAs (with X₁₄⁽²⁾˜700 pm/V) (Bergfeld, S.; Daum, W., Second-Harmonic Generation in GaAs: Experiment versus Theoretical Predictions of χxyz(2). Physical Review Letters 2003, 90, 036801; Wu, L.; Patankar, S.; Morimoto, T.; Nair, N. L.; Thewalt, E.; Little, A.; Analytis, J. G.; Moore, J. E.; Orenstein, J., Giant anisotropic nonlinear optical response in transition metal monopnictide Weyl semimetals. Nature Physics 2017, 13, 350-355), and greatly surpasses the X⁽²⁾ values of other common SHG materials, such as beta-barium borate (BBO, X⁽²⁾˜4.4 pm/V) and lithium niobate (LiNbO₃, X⁽²⁾˜63.6 pm/V) (Sutherland, R. L., Handbook of nonlinear optics. CRC press: 2003).

Besides, incorporating the monolayer crystal into various photonic components such as waveguides (Chen, H.; Corboliou, V.; Solntsev, A. S.; Choi, D. Y.; Vincenti, M. A.; de Ceglia, D.; de Angelis, C.; Lu, Y.; Neshev, D. N., Enhanced second-harmonic generation from two-dimensional MoSe₂ on a silicon waveguide. Light, Sci & Applic. 2017, 6 (10), e17060), optical fibers (Zuo, Y.; Yu, W.; Liu, C.; Cheng, X.; Qiao, R.; Liang, J.; Zhou, X.; Wang, J.; Wu, M.; Zhao, Y.; Gao, P.; Wu, S.; Sun, Z.; Liu, K.; Bai, X.; Liu, Z., Optical fibres with embedded two-dimensional materials for ultrahigh nonlinearity. Nature Nanotechnology 2020, 15, 987-991), plasmonic cavities (Hu, G.; Hong, X.; Wang, K.; Wu, J.; Xu, H.-X.; Zhao, W.; Liu, W.; Zhang, S.; Garcia-Vidal, F.; Wang, B.; Lu, P.; Qiu, C.-W., Coherent steering of nonlinear chiral valley photons with a synthetic Au-WS2 metasurface. Nature Photonics 2019, 13, 467-472; Wang, Z.; Dong, Z.; Zhu, H.; Jin, L.; Chiu, M.-H.; Li, L.-J.; Xu, Q.-H.; Eda, G.; Maier, S. A.; Wec, A. T. S.; Qiu, C.-W.; Yang, J. K. W., Selectively Plasmon-Enhanced Second-Harmonic Generation from Monolayer Tungsten Diselenide on Flexible Substrates. ACS Nano 2018, 12, 1859-1867; Wen, X.; Xu, W.; Zhao, W.; Khurgin, J. B.; Xiong, Q., Plasmonic Hot Carriers-Controlled Second Harmonic Generation in WSe2 Bilayers. Nano Letters 2018, 18, 1686-1692), photonic crystals (Fryett, T. K.; Seyler, K. L.; Zheng, J.; Liu, C.-H.; Xu, X.; Majumdar, A., Silicon photonic crystal cavity enhanced second-harmonic generation from monolayer WSe2. 2D Materials 2017, 4, 015031; Chen, B.; He, Z.; Liu, Z.-J.; Wang, Y.-K.; Gao, Y.-N.; Aharonovich, I.; Xu, Z.-Q.; Liu, J., Simultaneously enhanced linear and nonlinear photon generations from WS2 by using dielectric circular Bragg resonators. Nanophotonics 2020, 9, 2587-2592), and quantum dots (Hong, H.; Wu, C.; Zhao, Z.; Zuo, Y.; Wang, J.; Liu, C.; Zhang, J.; Wang, F.; Feng, J.; Shen, H.; Yin, J.; Wu, Y.; Zhao, Y.; Liu, K.; Gao, P.; Meng, S.; Wu, S.; Sun, Z.; Liu, K.; Xiong, J., Giant enhancement of optical nonlinearity in two-dimensional materials by multiphoton-excitation resonance energy transfer from quantum dots. Nature Photonics 2021, 15, 510-515) can further enhance its SHG conversion efficiency. However, the atomic thickness of the monolayer MoS₂ inevitably limits the optical cross-section for light-matter interaction, severely compromising its SHG performance that scales super linearly with the NLO medium thickness under phase matching conditions (Shen, Y.-R., Principles of nonlinear optics. 1984).

To boost the interaction with pumping light, it seems straightforward to utilize multilayer MoS₂ with a larger cross-section. Nevertheless, the naturally existing 2H-phase MoS₂ bulk crystal possesses the Bernal stacking order, which restores the centrosymmetry and prohibits second-order nonlinear processes (Li, Y.; Rao, Y.; Mak, K. F.; You, Y.; Wang, S.; Dean, C. R.; Heinz, T. F., Probing Symmetry Properties of Few-Layer MoS₂ and h-BN by Optical Second-Harmonic Generation. Nano Letters 2013, 13, 3329-3333). Unlike the centrosymmetric 2H-phase MoS₂, the 3R-phase polytype showed noncentrosymmetric stacking (Shi, J.; Yu, P.; Liu, F.; He, P.; Wang, R.; Qin, L.; Zhou, J.; Li, X.; Zhou, J.; Sui, X.; Zhang, S.; Zhang, Y.; Zhang, Q.; Sum, T. C.; Qiu, X.; Liu, Z.; Liu, X., 3R MoS₂ with Broken Inversion Symmetry: A Promising Ultrathin Nonlinear Optical Device. Adv. Mater. 2017, 29 (, 1701486; Zhao, M.; Ye, Z.; Suzuki, R.; Ye, Y.; Zhu, H.; Xiao, J.; Wang, Y.; Iwasa, Y.; Zhang, X., Atomically phase-matched second-harmonic generation in a 2D crystal. Light: Sci. & Applic.2016, 5, c16131; Yang, D.; Hu, X.; Zhuang, M.; Ding, Y.; Zhou, S.; Li, A.; Yu, Y.; Li, H.; Luo, Z.; Gan, L.; Zhai, T., Inversion Symmetry Broken 2D 3R-MoTe2. Adv. Funct. Mater. 2018, 28, 1800785), but often encountered problems of phase impurity and largescale synthetic challenges (Mishina, E.; Sherstyuk, N.; Lavrov, S.; Sigov, A.; Mitioglu, A.; Anghel, S.; Kulyuk, L., Observation of two polytypes of MoS₂ ultrathin layers studied by second harmonic generation microscopy and photoluminescence. Applied Physics Letters 2015, 106 (13)).

Another strategy to create noncentrosymmetric “bulk” MoS₂ is rolling monolayer MoS₂ into nanoscrolls using a solvent-evaporation-driven rolling method, which can enhance the SHG intensity by up to 95 times due to its enlarged cross-section (Qian, Q.; Zu, R.; Ji, Q.; Jung, G. S.; Zhang, K.; Zhang, Y.; Buchler, M. J.; Kong, J.; Gopalan, V.; Huang, S., Chirality-Dependent Second Harmonic Generation of MoS₂ Nanoscroll with Enhanced Efficiency. ACS Nano 2020, 14, 13333-13342). However, the uncontrollable rolling process is difficult to implement for large-scale integration in practical devices. On the other hand, it has been recently shown that a new class of monolayer atomic crystal molecular superlattices (MACMS) consisting of alternating layers of monolayer atomic crystals and organic molecules (Wang, C.; He, Q.; Halim, U.; Liu, Y.; Zhu, E.; Lin, Z.; Xiao, H.; Duan, X.; Feng, Z.; Cheng, R.; Weiss, N. O.; Ye, G.; Huang, Y.-C.; Wu, H.; Cheng, H.-C.; Shakir, I.; Liao, L.; Chen, X.; Goddard Iii, W. A.; Huang, Y.; Duan, X., Monolayer atomic crystal molecular superlattices. Nature 2018, 555, 231-236; Lin, Z.; Wan, Z.; Song, F.; Huang, B.; Jia, C.; Qian, Q.; Kang, J. S.; Wu, Y.; Yan, X.; Peng, L.; Wan, C.; Zhou, J.; Sofer, Z.; Shakir, I.; Almutairi, Z.; Tolbert, S.; Pan, X.; Hu, Y.; Huang, Y.; Duan, X., High-yield exfoliation of 2D semiconductor monolayers and reassembly of organic/inorganic artificial superlattices. Chem 2021, 7, 1887-1902; Yu, W.; Dong, Z.; Abdelwahab, I.; Zhao, X.; Shi, J.; Shao, Y.; Li, J.; Hu, X.; Li, R.; Ma, T.; Wang, Z.; Xu, Q.-H.; Tang, D. Y.; Song, Y.; Loh, K. P., High-Yield Exfoliation of Monolayer IT′-MoTe2 as Saturable Absorber for Ultrafast Photonics. ACS Nano 2021, 15, 18448-18457; Zhang, H.; Rousuli, A.; Zhang, K.; Luo, L.; Guo, C.; Cong, X.; Lin, Z.; Bao, C.; Zhang, H.; Xu, S.; Feng, R.; Shen, S.; Zhao, K.; Yao, W.; Wu, Y.; Ji, S.; Chen, X.; Tan, P.; Xuc, Q.-K.; Xu, Y.; Duan, W.; Yu, P.; Zhou, S., Tailored Ising superconductivity in intercalated bulk NbSe2. Nature Physics 2022, 18, 1425-1430; Zhou, B.; Zhou, J.; Wang, L.; Kang, J. H.; Zhang, A.; Zhou, J.; Zhang, D.; Xu, D.; Hu, B.; Deng, S.; Huang, L.; Wong, C. W.; Huang, Y.; Duan, X., A chemical-dedoping strategy to tailor electron density in molecular-intercalated bulk monolayer MoS₂. Nature Synthesis 2023), can retain the physical properties of monolayer materials while exhibiting extended thickness of bulk materials, which have also been referred to as “bulk monolayer materials” with tailored thermal, electrical, and optical properties (Id.). Such bulk monolayer materials preserve the noncentrosymmetric nature of monolayer crystals while featuring a tunable optical cross-section for light-matter interaction, thus offering an interesting system for exploring SHG.

The present embodiments relate to a giant SHG enhancement in solution-assembled bulk monolayer MoS₂ (BM-MoS₂) thin films. With alternating layers of monolayer MoS₂ separated by organic molecular layers, the BM-MoS₂ retains crucial monolayer properties, including the direct bandgap, robust excitonic resonance, and, importantly, the lack of inversion symmetry required for SHG. In the meantime, the thickness of the BM-MoS₂ can be readily scaled up in the solution assembly process, greatly enhancing light-matter coupling in both linear and nonlinear optical processes. Strikingly, studies performed by the present Applicant reveal that BM-MoS₂ feature a giant SHG efficiency enhancement of up to 126 times of the monolayer MoS₂ and 21 times of the benchmark single crystalline GaAs wafers. Theoretical modeling further verifies the optical field enhancement within the BM-MoS₂ thin film, leading to boosted light coupling and SHG performance. The facile and scalable synthesis of BM-MoS₂ thin films could offer opportunities for cost-effective and ultra-compact on-chip NLO devices.

### Results and Discussion

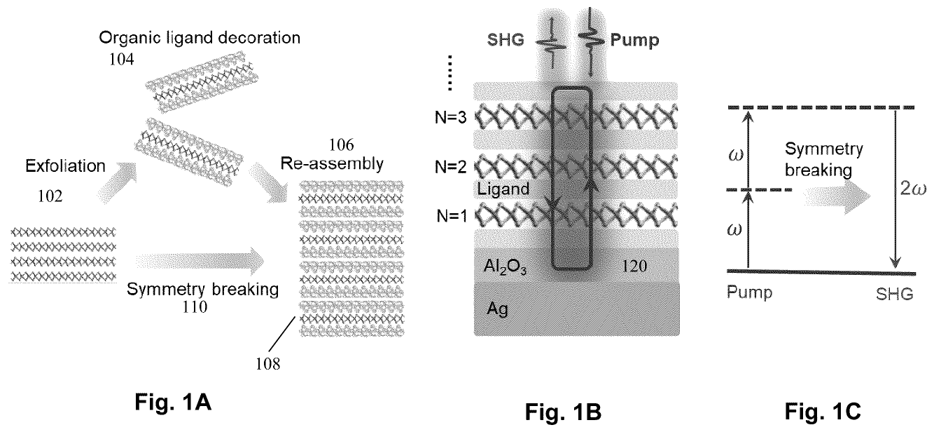

The preparation of BM-MoS₂ thin films involves a solution-exfoliation procedure to transform the original centrosymmetric bulk MoS₂ crystals into noncentrosymmetric monolayer MoS₂ nanosheets capped with organic molecules such as poly (vinylpyrrolidone) (PVP). FIGS. 1A to 1C illustrate example aspects of bulk monolayer MoS₂ thin film structure and second harmonic generation (SHG) according to embodiments. FIG. 1A is a schematic illustration of example aspects of BM-MoS₂ thin films preparation according to embodiments. For example, the preparation includes 102: exfoliation of 2H phase bulk MoS₂ into monolayers and 104: organic ligand decoration of the MoS₂ monolayers, followed by 106: the random reassembly of monolayers capped with organic ligands. The solution assembly of the exfoliated monolayers using spray coating process produces scalable large-area BM-MoS₂ thin films 108 with alternating layers of monolayer MoS₂ nanosheets and organic molecules. With the organic spacer layer separating MoS₂ monolayers and preventing interlayer interaction, the resulting BM-MoS₂ exhibits inversion symmetry breaking 110 and preserves the intrinsic NLO parameters of monolayer MoS₂, while overcoming the thickness limitations of intrinsic monolayer materials.

FIG. 1B is a schematic illustration of embodiments of SHG enhancement induced by the extended interaction between BM-MoS₂ and the pumping light according to embodiments. In this case, superior SHG efficiency is attainable in BM-MoS₂ thin films on a simple reflective substrate (Ag/Al₂O₃) 120, where the fundamental wave strongly couples into the NLO medium. FIG. 1C is a schematic illustration of example aspects of second harmonic generation (SHG) according to embodiments where inversion symmetry breaking is required.

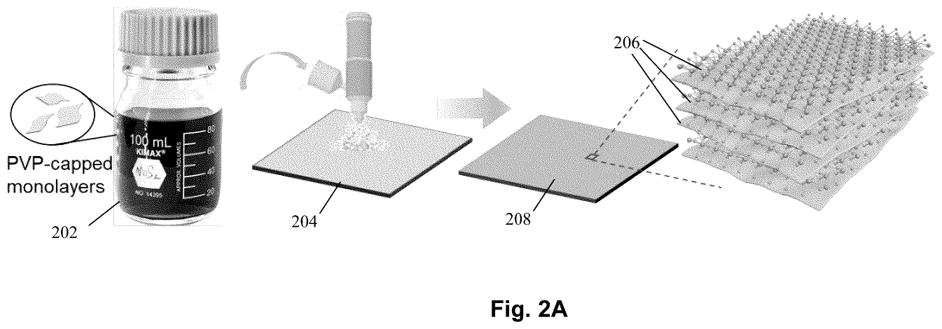

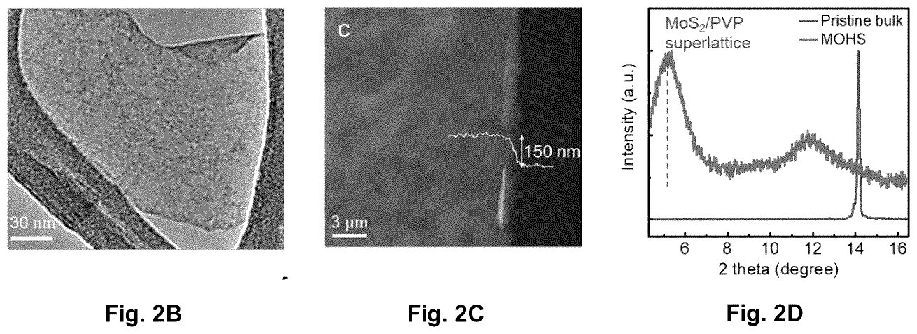

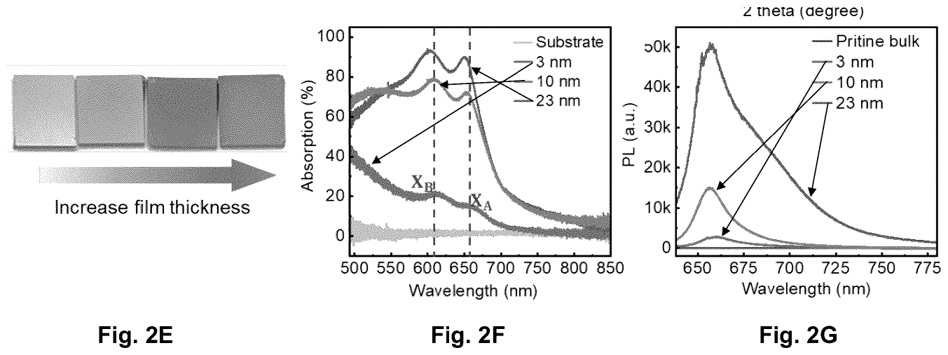

FIGS. 2A to 2G illustrate aspects of example embodiments of preparation and characterizations of the BM-MoS₂ thin films. FIG. 2A is a schematic illustration of an example BM-MoS₂ thin films assembly process, achieved by spray-coating of PVP-capped MoS₂ monolayer ink 202 on a chosen substrate 204. FIG. 2B provides an example transmission electron microscopy (TEM) image of a single MoS₂ sheet partially capped with PVP molecules. FIG. 2C provides an example atomic force microscopy (AFM) image of the as-sprayed BM-MoS₂ thin film with an average thickness of 150 nm. FIG. 2D is a graph illustrating example X-ray diffraction (XRD) patterns of pristine bulk MoS₂ (black) and BM-MoS₂ thin films (red). FIG. 2E provides photographs of a bare substrate coated with 80 nm Ag and 30 nm Al₂O₃ and BM-MoS₂ thin films with increasing thicknesses (3, 10, 23 nm). FIGS. 2F and 2G are example optical absorption and photoluminescence (PL) spectra of the BM-MoS₂ of various thicknesses, respectively.

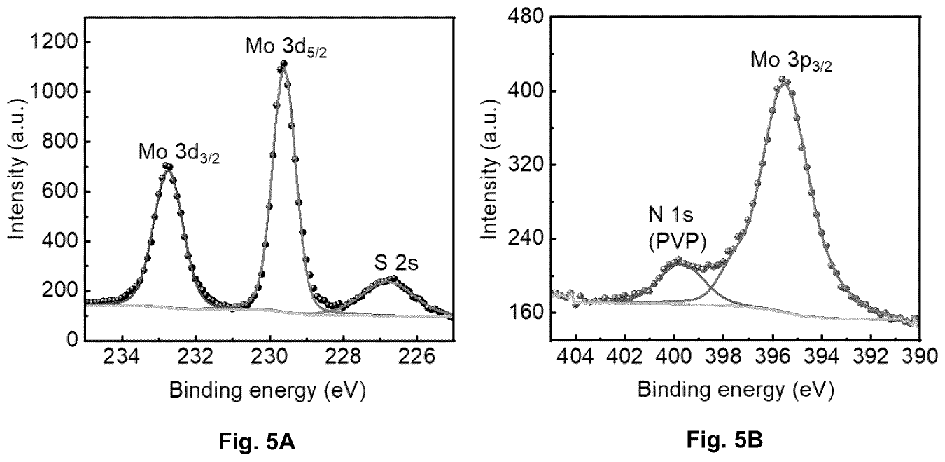

More particularly, to prepare example BM-MoS₂ thin films of embodiments, monolayer MoS₂ ink is first prepared using a reported intercalation and separation process (Rangnekar, S. V.; Sangwan, V. K.; Jin, M.; Khalaj, M.; Szydłowska, B. M.; Dasgupta, A.; Kuo, L.; Kurtz, H. E.; Marks, T. J.; Hersam, M. C., Electroluminescence from Megasonically Solution-Processed MoS₂ Nanosheet Films. ACS Nano 2023, 17, 17516-17526; Lin, Z.; Liu, Y.; Halim, U.; Ding, M.; Liu, Y.; Wang, Y.; Jia, C.; Chen, P.; Duan, X.; Wang, C.; Song, F.; Li, M.; Wan, C.; Huang, Y.; Duan, X., Solution-processable 2D semiconductors for high-performance large-area electronics. Nature 2018, 562, 254-258) (see details in Example Method), and dispersed in isopropanol to formulate a stable and easy-to-handle ink after binding with organic ligands (PVP), as evident by the transmission electron microscopy (TEM) image (e.g. FIG. 2B). The monolayer MoS₂ ink is then spray-coated onto a selected substrate to form large-area continuous BM-MoS₂ thin films, where the PVP-capped MoS₂ monolayers 206 are stacked vertically to form a MoS₂/PVP superlattice thin film 208. An atomic force microscopy (AFM) image (e.g. FIG. 2C) shows that the thickness of the spray-coated film can be tailored up to hundreds of nanometers. X-ray diffraction (XRD) studies of the resulting thin film (e.g. FIG. 2D) show that the (002) diffraction peak was significantly shifted to the lower diffraction angle with an interlayer periodicity of 1.70 nm, substantially larger than the interlayer spacing of 0.63 nm in pristine 2H-phase bulk crystals. This confirmed the formation of a superlattice structure with alternating layers of 2D MoS₂ and organic ligands. The presence of PVP ligands in the BM-MoS₂ thin films was also verified by elemental analysis based on X-ray photoelectron spectroscopy (XPS), where a molar ratio of 42% between the PVP monomer and Mo atoms was estimated (e.g. FIG. 5B).

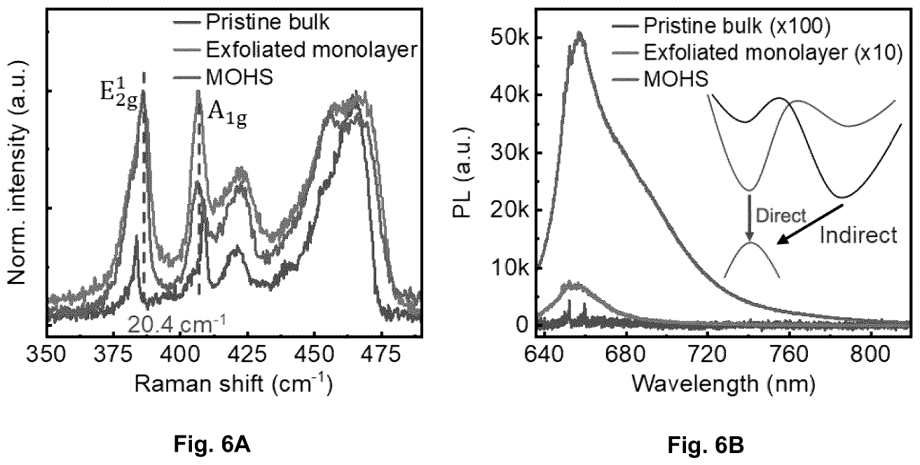

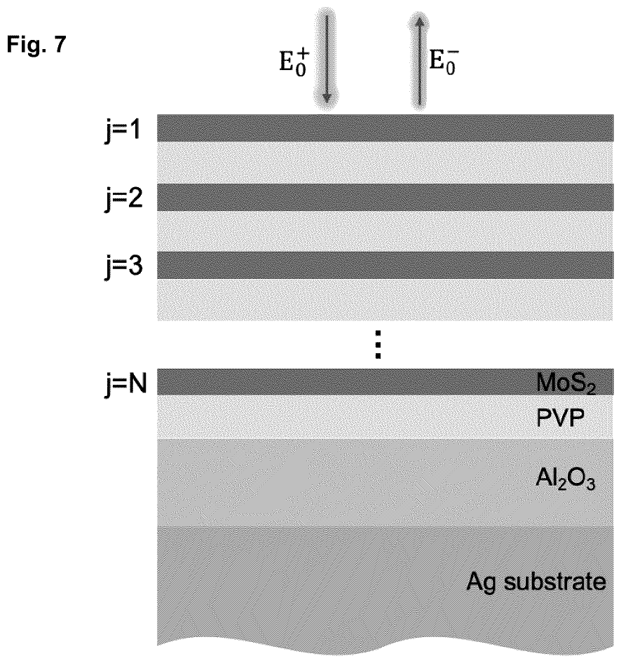

The organic molecule layers embedded between 2D MoS₂ layers isolate interlayer electronic and vibrational interactions and are essential for retaining the monolayer physical properties of the monolayer MoS₂ in the resulting superlattice thin film. It is known that MoS₂ shows distinct layer-dependent spectroscopic features (Mak, K. F.; Lee, C.; Hone, J.; Shan, J.; Heinz, T. F., Atomically Thin MoS₂: A New Direct-Gap Semiconductor. Physical Review Letters 2010, 105, 136805; Gołasa, K.; Grzeszczyk, M.; Bożek, R.; Leszczyński, P.; Wysmołek, A.; Potemski, M.; Babiński, A., Resonant Raman scattering in MoS₂—From bulk to monolayer. Solid State Communications 2014, 197, 53-56; Li, H.; Zhang, Q.; Yap, C. C. R.; Tay, B. K.; Edwin, T. H. T.; Olivier, A.; Baillargeat, D., From Bulk to Monolayer MoS₂: Evolution of Raman Scattering. Advanced Functional Materials 2012, 22, 1385-1390). Importantly, the wavenumber difference between the in-plane Raman mode (E₂_{_{g}}¹) and the out-of-plane mode (A₁_{_{g}}) in BM-MoS₂ thin films showed a considerably shrunk value of 20.4 cm⁻¹ (e.g. FIG. 6A), which is on par with that of the intrinsic monolayer MoS₂ (Id.) and notably smaller than that of the original bulk crystal (24.9 cm⁻¹).

Additionally, the resulting BM-MoS₂ showed a prominent photoluminescence (PL) emission more than three orders of magnitude brighter than that of the indirect-bandgap bulk counterpart (FIG. 6B), further confirming the MoS₂ layers in the BM-MoS₂ retain direct bandgap nature of monolayer MoS₂ materials (Id.).

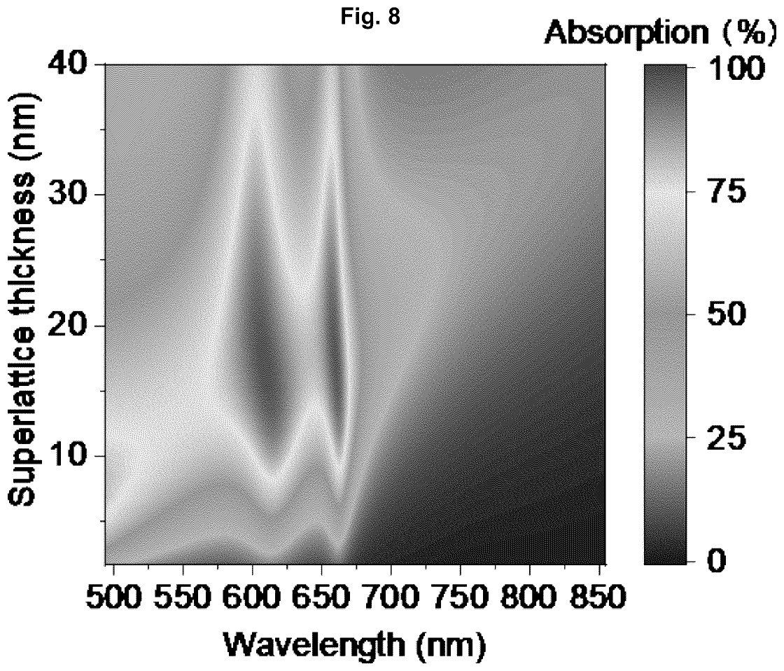

The centimeter-scale BM-MoS₂ thin films deposited on a reflective substrate showed a distinct color evolution with increasing thicknesses (e.g. FIG. 2E), indicating gradually changing optical absorption. The absorption spectra of the resulting thin film showed substantial light extinction in thin films with a rather modest thickness (FIG. 2F). Strikingly, excitonic absorption evolved to over 90% in a BM-MoS₂ thin film with ˜23 nm thickness (˜13-14 MoS₂ monolayers). To understand such highly efficient optical absorption, the absorption properties based on transfer-matrix calculation were further simulated (see details below, Note 1), and it was found nearly perfect absorption (˜98%) can be achieved near the A and B exciton energy levels at a moderate thickness of 18 nm (e.g. FIG. 8). With the high refractive index of the MoS₂ (>5) near its exciton bands, the BM-MoS₂ thin film naturally forms a Fabry-Perot cavity between a bottom mirror of the substrate and a top mirror of Air/BM-MoS₂ interface. This configuration enables the BM-MoS₂ to exhibit constructive optical interference at an ultra-thin thickness, resulting in the enhanced light absorption. Similarly, a notable enhancement of excitonic PL emission can be achieved in the BM-MoS₂ thin film (FIG. 2G), with the highest emission intensity achieved in the 23 nm thin film ˜8000 times higher than that of bulk MoS₂ and 74 times higher than that of exfoliated monolayer under the same excitation conditions (FIG. 6B).

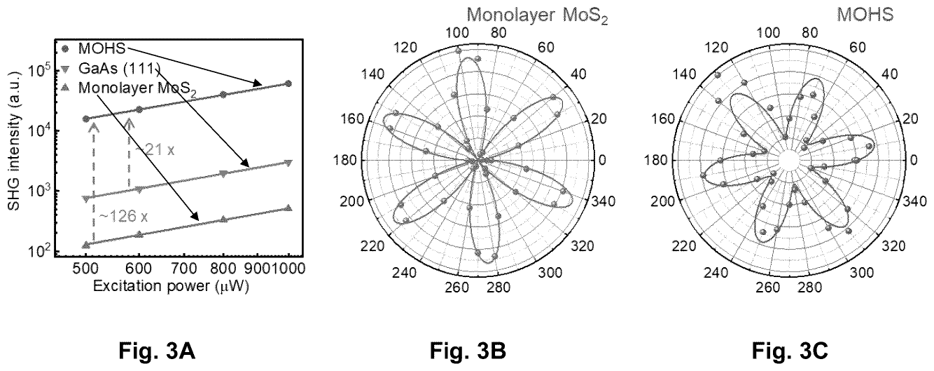

FIGS. 3A to 3C illustrate example aspects of SHG characterizations. FIG. 3A is a graph illustrating aspects of excitation power dependent SHG of a BM-MoS₂ thin film in comparison with monolayer MoS₂ and GaAs single crystalline wafer (111). A quadratic power dependence is observed in all cases. FIGS. 3B and 3C illustrate example aspects of SHG polarization dependence of the monolayer MoS₂ and the BM-MoS₂ thin films of embodiments, respectively.

As shown, the significantly boosted light-matter interaction in the BM-MoS₂ thin films not only leads to pronounced linear optical process but also more notably the nonlinear photon generation such as SHG, which is normally rather weak and requires extended interaction between the fundamental wave and the NLO medium. Indeed, the BM-MoS₂ thin films of embodiments show prominent SHG signals when pumped with a Ti: sapphire femtosecond laser system operating at 780 nm (see further details below). Excitation power dependence studies revealed that the resulting SHG signal from the BM-MoS₂ thin films exhibited a quadratic intensity increase as a function of the pumping power (FIG. 3A), similar to that of monolayer MoS₂ and single crystal GaAs wafer, confirming nonlinear origin of the SHG signal. Significantly, the SHG of a ˜30 nm thick BM-MoS₂ thin film showed a remarkable 126-time enhancement when compared with that of the monolayer MoS₂, and an essentially infinite enhancement when compared to the pristine bulk 2H-phase MoS₂ that showed negligible SHG signal below the detection limit due to its intrinsic inversion symmetry. Moreover, the SHG intensity of the BM-MoS₂ thin film was 21 times stronger than that of the single crystal GaAs wafer, which is a well-characterized benchmark material with large SH susceptibilities (X₁₄⁽²⁾˜700 pm/V).

Further conducted was a polarization-resolved SHG study to investigate the SHG origin. The D₃ₕ symmetry group of monolayer MoS₂ leads to a six-fold symmetry in its SHG polar plot as a function of polarization angle. Thus, the experimentally measured SHG in monolayer MoS₂ (FIG. 3B) can be well fitted by the I₀ cos²(3θ+φ) function under the co-polarization configuration (excitation and detection polarizations were set parallel), where I₀, θ, and φ are the maximum SHG intensity, the rotation angle of the laser polarization, and the initial angle between laser polarization and the armchair direction of MoS₂, respectively. For the BM-MoS², the SHG exhibited a partly depolarized six-fold symmetry (FIG. 3C). The depolarization effect can be explained by the random MoS₂ rotational angle in each unit cell of the BM-MoS₂ (i.e., varied φ angle). Nevertheless, an overall six-fold symmetry should be maintained when the D₃ₕ symmetry is preserved in each MoS₂ layer, which results in six-fold petals with an elevated baseline, as observed in FIG. 3C) (see Note 2 below for further discussions). Additionally performed were SHG measurements of the bare substrate (silicon (100) wafer coated with 80 nm Ag and 30 nm Al₂O₃ capping layer) and the PVP thin film, but no SHG signals were observed. Therefore, one can conclude that the SHG observed in the BM-MoS₂ originates solely from the inherent NLO response of the monolayer MoS₂ in each unit cell of the superlattice structure.

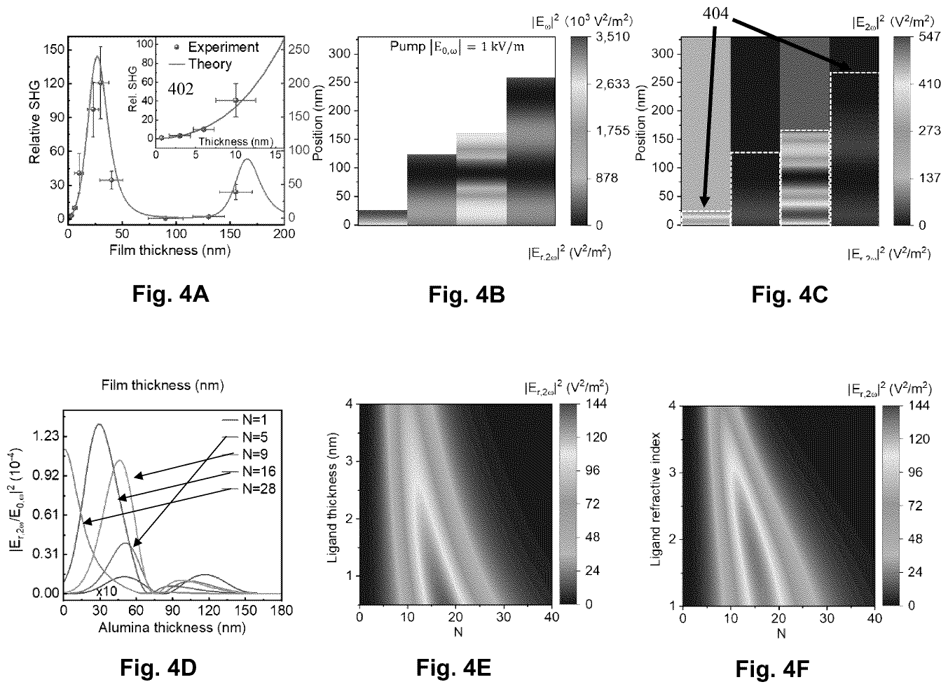

FIGS. 4A to 4F illustrate example aspects of thickness-dependent SHG and electromagnetic modeling according to embodiments. FIG. 4A is a graph illustrating experimental and modeled SHG intensity from BM-MoS₂ (relative to the monolayer MoS₂) as a function of the film thickness. The inset 402 shows a super linear increase of SHG with BM-MoS₂ thickness (For reference, the first experimental point was the intrinsic monolayer (˜0.65 nm) SHG). FIGS. 4B and 4C are charts showing example intensity distribution of the fundamental field (|E_{ω}|²) and SH field (|E_{2ω}|²), respectively, for the BM-MoS₂ at four different thicknesses (N=16, 74, 97, 154) under normal light illumination (the pumping field amplitude |E_{0,2ω}| was set as 1 kV/m). The four dashed rectangles 404 in FIG. 4C indicate the cross-section of BM-MoS₂ structures with different thicknesses, while the regions above each rectangle represent the upper free space. FIG. 4D is a graph illustrating example SHG efficiency defined by the ratio between radiated SH intensity (|E_{r,2ω}|²) and incident pumping intensity (|E_{0,2ω}|²) with varied superlattice unit cell number (N) (N=1, black, 10× magnification) as a function of the bottom alumina layer thickness. FIG. 4E is a color map of |E_{r,2ω}|² as a function of the organic ligand layer thickness and N. FIG. 4F is a color map of |E_{r,2ω}|² as a function of the refractive index of the organic ligand layer and N.

As can be seen from these figures, the BM-MoS₂ thin films also provide a platform for exploring SHG properties with a degree of freedom in thickness. FIG. 4A displays the experimentally measured SHG as a function of the BM-MoS₂ thin film thickness ranging from 3 nm to more than 150 nm. Starting from the BM-MoS₂ thin film with 3 nm thickness, the SHG intensity rapidly increases with increasing thickness before reaching a maximum at a thickness around 30 nm, followed by an intensity drop with further increasing thickness. To understand the SHG modulation by thickness, adopted was a theoretical model based on a transfer matrix method (Li, J.-J.; Li, Z.-Y.; Zhang, D.-Z., Second harmonic generation in one-dimensional nonlinear photonic crystals solved by the transfer matrix method. Physical Review E 2007, 75, 056606). This method considers multiple internal reflections and interference effects from fundamental and second harmonic waves within the multilayered superlattice medium (see Note 3 below). At a fixed pump intensity, one can quantitatively calculate the emitted SHG intensity at varying unit cell numbers (N). The simulated results showed a super linear thickness-dependent SHG increase for the BM-MoS₂ thin films thinner than 20 nm, with a maximum SHG intensity enhancement of 235-fold in the N=16-layer BM-MoS₂ thin film (thickness 28.2 nm) compared to monolayer MoS₂ on the same substrate (FIG. 4A and inset). Further increasing the BM-MoS₂ thickness leads a periodically modulated SHG signal with the thickness (see red curve in FIG. 4A), which can be attributed to the interference effect within the BM-MoS₂-substrate Fabry-Perot cavity. Significantly, this experimental data show remarkably consistent trend with the simulation (FIG. 4A).

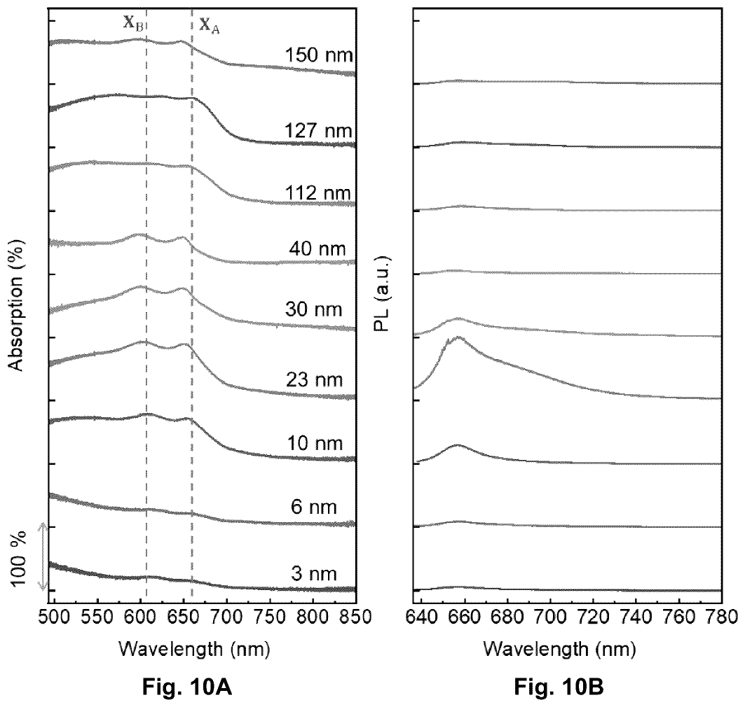

Moreover, further calculated was the distribution of the light field inside the superlattice. It was assumed that X⁽²⁾=160 pm/V at the SH wavelength of 390 nm for monolayer MoS₂ and the incident pump field was set at an amplitude of |E_{0,ω}|=1 kV/m in the simulation. To get a straightforward understanding, plotted were the intensity distribution of both the fundamental field intensity (|E_{ω}|²) and the generated SH intensity (|E_{2ω}|²) in the BM-MoS₂ thin films at four distinct thicknesses (N=16, 74, 97, 154). Apparent interference patterns were observed for both fundamental and SH fields within the BM-MoS₂ thin films (FIGS. 4B and 4C). The fundamental wave interfered constructively when N=16 and 97, leading to a 3.5-time enhancement of the pump intensity inside the superlattice; and destructively interfered when N=74 and 154, resulting in a near-zero light field in certain parts of the superlattice cross-section. For the SH field, it was observed that the peak positions of SHG tended to occur slightly below the location where the fundamental field exhibited its peak intensity. This phenomenon can be attributed to the much shorter wavelength of the generated SH wave, which reconfigures its mode distribution within the BM-MoS₂ thin films. As anticipated, observed was pronounced SHG emission in the BM-MoS₂ thin films with thickness that is favorable for constructive interference of the fundamental field, while it was attenuated in the BM-MoS₂ thin films with the thickness that supports destructive interference. Similar modulation of light absorption and PL emission by thickness was also observed (FIGS. 10A and 10B), further confirming the change of interference modes at varied BM-MoS₂ thickness.

The experiment used a protected mirror substrate (e.g. silver film capped by 30 nm alumina, as described above in connection with FIG. 1B) to minimize transmission loss of the incident fundamental wave. To study the substrate influence on SHG, quantitatively calculated was the SHG efficiency as a function of the bottom alumina thickness for the BM-MoS₂ thin films with varying unit cell numbers (N) (FIG. 4D). Under a pumping field amplitude (|E_{0,ω}|) of 1 kV/m, the SHG efficiency (|E_{r,2ω}/E_{0,ω}|²) of monolayer MoS₂ (N=1) increased from 1.51×10⁻⁹ to 1.50×10⁶ V²/m² with increasing alumina thickness from 0 to 117 nm (black curve in FIG. 4D). The three orders of magnitude SHG change come from the Fabry-Perot interference within the underlying dielectric, which amplifies the optical field at the MoS₂-dielectric interface and has been widely applied to boost the optical response in 2D materials (Li, S.-L.; Miyazaki, H.; Song, H.; Kuramochi, H.; Nakaharai, S.; Tsukagoshi, K., Quantitative Raman Spectrum and Reliable Thickness Identification for Atomic Layers on Insulating Substrates. ACS Nano 2012, 6, 7381-7388; Casiraghi, C.; Hartschuh, A.; Lidorikis, E.; Qian, H.; Harutyunyan, H.; Gokus, T.; Novoselov, K. S.; Ferrari, A. C., Rayleigh Imaging of Graphene and Graphene Layers. Nano Letters 2007, 7, 2711-2717; Kudryavtsev, A. V.; Lavrov, S. D.; Shestakova, A. P.; Kulyuk, L. L.; Mishina, E. D., Second harmonic generation in nanoscale films of transition metal dichalcogenide: Accounting for multipath interference. AIP Advances 2016, 6). However, SHG efficiency from the monolayer MoS₂ remained low (1.50×10⁻⁶ at 1 kV/m pump) even at the optimized alumina thickness. In contrast, much higher SHG is achieved for the BM-MoS₂ thin film with an optimum thickness (N=16), where SHG efficiency reached 1.32×10⁻⁴ (at 1 kV/m pump) at a much thinner bottom alumina of 30 nm (blue curve in FIG. 4D). When further increased was the unit cell number, the BM-MoS₂ thin film at N=28 demonstrated comparable SHG efficiency (1.13×10⁻⁴) even without bottom alumina. The superior SHG performance of the BM-MoS₂ thin films stems from the Fabry-Perot interference mainly occurring within the NLO medium (i.e., BM-MoS₂) rather than the underlying dielectrics, leading to improved spatial overlap between the BM-MoS₂ thin film and the enhanced pumping field. This also suggests that BM-MoS₂ thin films, with their readily tunable optical cross-section, are less susceptible to the substrate materials for SHG than its monolayer counterpart, which is beneficial for NLO applications.

Additionally, conducted were theoretical investigations to explore the influence of the organic molecular layer properties on SHG efficiency by adjusting its refractive index and thickness. Studies revealed that the highest SHG output remained relatively stable when the organic layer thickness was less than 2 nm but displayed a notable decrease beyond 2.4 nm thickness (FIG. 4E). This suggests that when the organic component with zero X⁽²⁾ increases, it results in a reduction in the effective NLO susceptibility of the entire BM-MoS₂ thin film, subsequently impairing the SHG performance. Calculations also showed that the SHG intensity exhibited a substantial decrease when the ligand refractive index approached that of the MoS₂ (˜4.26 at 780 nm) (FIG. 4E). A higher refractive index of the organic layer shortens the necessary optical path for constructive interference in the Fabry-Perot cavity, leading to fewer MoS₂ layers interacting with the pumping light and in turn reducing SHG radiation. On the other hand, SHG will also decrease for a superlattice without organic layers due to interlayer electronic interactions and symmetry restoration. Importantly, the BM-MoS₂ thin films displayed a stable SHG performance when the organic ligand thickness was less than 2.4 nm and refractive index less than 3. This suggests that the solution-processed BM-MoS₂ thin films created by the simple rapid spray-coating process is robust for SHG applications. These analyses highlight the construction of the monolayer MoS₂ organic hybrid superlattice structure in BM-MoS₂ thin films with ultrathin organic layers (<2 nm) and low refractive index is essential for achieving the enhanced SHG.

In conclusion, the present disclosure provides a solution-processed BM-MoS₂ thin film that retains the inherent optical susceptibility of monolayer MoS₂, while showing significantly increased optical cross-sections, leading to a pronounced enhancement in both linear and nonlinear photon generation. Studies demonstrate remarkable SHG efficiency in the BM-MoS₂, which is more than two orders of magnitude higher than monolayer MoS₂ and 21 times higher than GaAs bulk single crystal. The BM-MoS₂ thin films can be rapidly produced on a large scale and easily integrated with other photonic components, promising a scalable pathway to harnessing the potential of 2D materials for the creation of ultrathin, efficient, and cost-effective NLO devices.

### CONCLUSION

### Example Methods

Example Preparation of BM-MoS₂ thin films. First prepared was MoS₂/isopropanol (IPA) ink using a known intercalation/exfoliation method. Specifically, a MoS₂ bulk crystal was attached to a copper wire as the cathode and a graphite rod was used as the anode. Both electrodes were dipped into a tetraethylammonium bromide (THAB, 98% from TCI) acetonitrile solution (5 mg/mL) for electrochemical intercalation. To ensure a more thorough intercalation, used was a higher voltage of −8.5 V applied to the MoS₂ cathode during the electrochemical intercalation, extended over a longer time (˜90 minutes). Next, the intercalated crystal was subject to sonication in a PVP (M. W. 8000) dimethylformamide (DMF) solution (18 mg/mL) for one hour, creating an ink consisting of exfoliated MoS₂ nanosheets bonded with PVP ligands. Next, used was high-speed centrifugation at 12100 rpm/s to exchange the solvent into IPA, followed by washing with IPA twice via high-speed centrifugation to remove the organic cations (THA⁺) introduced during intercalation. Subsequently, iteratively centrifuged was the ink at 3500 rpm/s for 5 minutes and discarded were the precipitates. After six cycles of centrifugation, one could obtain a monolayer MoS₂ dispersion where thick nanosheets were removed from the ink. Finally, spray-coated was the as-prepared ink on oxygen-plasma-treated substrates. For the preparation of Ag/Al₂O₃substrates, first deposited was an 80 nm-thick silver film on a silicon wafer, followed by the deposition of 30 nm thick alumina via a standard atomic layer deposition (ALD) process.

Structural Characterizations. Structural characterizations were performed using XRD (Panalytical X'Pert Pro X-ray Powder Diffractometer), TEM (Titan S/TEM (FEI): 300 kV acceleration voltage), and AFM (Bruker Dimension Icon Scanning Probe Microscope).

Spectroscopic Characterizations. The Raman and PL spectra under 633 nm laser excitation were carried out using a Horiba Lab Ram 401 HR Evolution confocal Raman system. The absorption spectra were obtained by measuring the reflectance spectra using the same system with a white lamp source.

SHG Characterizations. Second harmonic generation setup was built by a back scattering geometry configuration, and Ti: Sapphire (Mai Tai-Spectra Physics) at 780 nm with 80 MHz repetition rate was used to excite the sample with a 80× Mitutoyo objective lens to gather the SHG signal from it. Used were two 2/2 waveplates (covering excitation 780 nm and SHG 390 nm) and one linear polarizer to measure polarization-resolved SHG measurements. In addition, used was a ST-500 cryostat to make vacuum environments of the sample during the measurements and thus avoid any damages from the laser and ambient conditions. For the detecting parts, used were a dichroic mirror and Pelin-Broca prism to mechanically separate the fundamental and its harmonic light. In addition, to rotate the Pelin-Broca prism, one can select SHG signal and send it to photomultiplier tube (Hamamatsu H11890) to measure the SHG intensity. Used were all the mirrors as dielectric mirrors on the setup, which minimizes reflecting loss of SHG wavelength range. Located were appropriate long pass filters and band pass filters accordingly after each waveplate to remove the SHG signal from its fast axis.

### Example Supplementary Notes

### Note 1: Transfer Matrix Method for Optical Absorption Modeling

In one physical model, it was proposed that an incident plane electromagnetic (e.m.) wave with electric-field (E) amplitude of E₀⁺ shined on the BM-MoS₂ thin films with N layers of MoS₂ monolayers, as depicted in FIG. 8. Hence, light absorption coefficient of the overall structure can be acquired by calculating the electric field amplitude of the reflected e.m. wave (E₀⁻). The sign +(−) represents the forward and back-reflected propagating wave. Then, defined are the transfer matrices (D₁ and P₁) of MoS₂ layer and the transfer matrices (D₂ and P₂) of the organic layer (PVP) as

$${D}_{1} = ( \begin{matrix}1 & 1 \\ {n}_{1} & - {n}_{1}\end{matrix} ) \qquad ( S1 )$$

$${P}_{1} = ( \begin{matrix}exp ( \frac{2 i π {n}_{1}}{λ} {d}_{1} ) & 1 \\ {n}_{1} & - exp ( \frac{2 i π {n}_{1}}{λ} {d}_{1} )\end{matrix} ) \qquad ( S2 )$$

$${D}_{2} = ( \begin{matrix}1 & 1 \\ {n}_{2} & - {n}_{2}\end{matrix} ) \qquad ( S3 )$$

$${P}_{2} = ( \begin{matrix}exp ( \frac{2 i π {n}_{2}}{λ} {d}_{2} ) & 1 \\ {n}_{2} & - exp ( \frac{2 i π {n}_{2}}{λ} {d}_{2} )\end{matrix} ) \qquad ( S4 )$$

where n₁, n₂, λλ, d₁, d₂, d₃ are the refractive index of monolayer MoS₂, refractive index of PVP, wavelength of the incident light (780 nm), thickness of monolayer MoS₂, thickness of PVP layer, thickness of the bottom alumina, respectively. Similarly, the transfer matrix of air (D₀), bottom alumina (D₃ and P₃), and the silver (Ag) substrate (D_{Ag}) are written as

$${D}_{0} = ( \begin{matrix}1 & 1 \\ {n}_{0} & - {n}_{0}\end{matrix} ) \qquad ( S5 )$$

$${P}_{3} = ( \begin{matrix}exp ( \frac{2 i π {n}_{3}}{λ} {d}_{3} ) & 1 \\ {n}_{1} & - exp ( \frac{2 i π {n}_{3}}{λ} {d}_{3} )\end{matrix} ) \qquad ( S6 )$$

$${D}_{3} = ( \begin{matrix}1 & 1 \\ {n}_{3} & - {n}_{3}\end{matrix} ) \qquad ( S7 )$$

$${D}_{Ag} = ( \begin{matrix}1 & 1 \\ {n}_{Ag} & - {n}_{Ag}\end{matrix} ) \qquad ( S8 )$$

Next, the overall transfer matrix (T) of the optical structure with N layers of MoS₂ and PVP can be written as

$$T = {D}_{Ag}^{- 1} {P}_{3} {{D}_{3}^{- 1} ( {D}_{2} {P}_{2} {D}_{2}^{- 1} {D}_{1} {P}_{1} {D}_{1}^{- 1} )}^{N} {D}_{0} \qquad ( S9 )$$

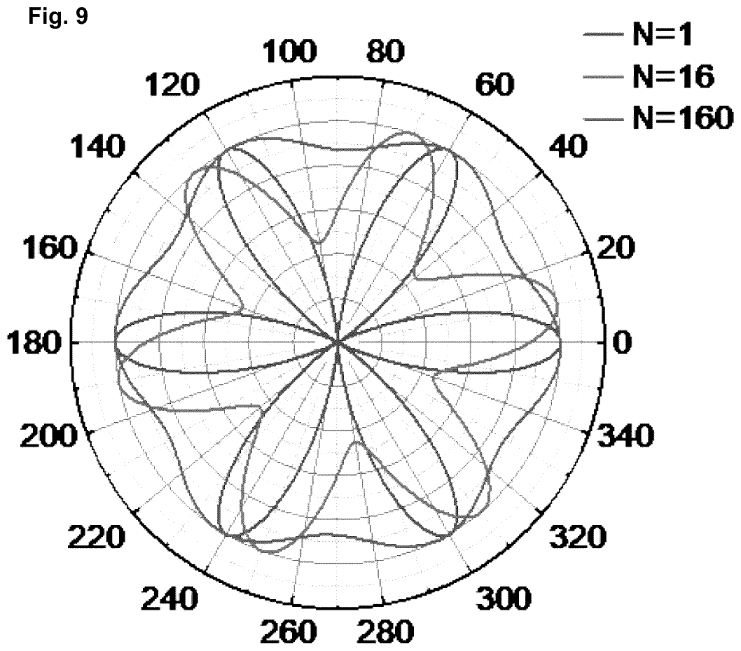

From the transfer matrix, one can solve the E field amplitude by the following equation:

$$( \begin{matrix}{E}_{t}^{+} \\ 0\end{matrix} ) = T ( \begin{matrix}{E}_{0}^{+} \\ {E}_{0}^{-}\end{matrix} ) \qquad ( S10 )$$

where Eₜ⁺ denotes the E field amplitude just underneath the interface of Ag and alumina. Finally, light absorption is obtained as A=1−|E₀⁻|²/|E₀⁺|². In this model, the complex refractive index of monolayer MoS₂ and Ag were referred from Song, B.; Gu, H.; Fang, M.; Chen, X.; Jiang, H.; Wang, R.; Zhai, T.; Ho, Y.-T.; Liu, S., Layer-Dependent Dielectric Function of Wafer-Scale 2D MoS₂. Advanced Optical Materials 2019, 7, 1801250 and Johnson, P. B.; Christy, R. W., Optical Constants of the Noble Metals. Physical Review B 1972, 6, 4370-4379. The refractive index of PVP was approximated as a constant value of 1.53. According to the XRD results, the thickness of MoS₂ and PVP in each unit cell is taken as 0.630 nm and 1.065 nm, respectively. Hence, one can calculate the optical absorption spectra as a function of the unit cell number (i.e., the thicknesses of the BM-MoS₂ thin films). As shown in FIG. 9, near perfect excitonic absorption (˜98%) can be achieved at a thickness around 20 nm.

### Note 2: Polarization-Dependent SHG in BM-MoS₂ Thin Films

SHG intensity is a function of the excitation laser polarization and the polarization direction of the analyzer. For the D₃ₕ crystal symmetry of monolayer MoS₂, I_{2ω}=I₀ cos²(3θ+φ) when excitation and analyzer polarization are kept parallel with each other, where θ and φ are rotation angle of laser polarization and the initial angle between laser polarization and the armchair direction of MoS₂, respectively. However, the SHG of the BM-MoS₂ thin films is composed by the signal of multiple MoS₂ flakes with arbitrary rotational angles (i.e., φ). Thus, one may write the polarization dependence of BM-MoS₂ as I_{2ω}=Σᵢ^{N} Iᵢ cos²(3θ+φᵢ), meaning that the SHG signal was coming from N different MoS₂ with varied qi. For sake of simplicity, it is assumed that all MoS₂ flakes have an equal I₀ value (i.e., Iᵢ=I₀). It is found that the three-fold symmetry of the SHG polarization dependence is still preserved in BM-MoS₂, as derived below:

$${I}_{2 ∞} = {\sum }_{i}^{N} {I}_{0} {cos}^{2} ( 3 θ + {φ}_{i} ) = A + B {cos}^{2} ( 3 θ + α ) \qquad ( S11 )$$

where A, B, and α are defined as

$$A = \frac{{NI}_{0}}{2} - {I}_{0} / 2 \sqrt{{( {\sum }_{i}^{N} cos ( 2 {φ}_{i} ) )}^{2} + {( {\sum }_{i}^{N} sin ( 2 {φ}_{i} ) )}^{2}} ,$$

$$B = {I}_{0} \sqrt{{( {\sum }_{i}^{N} cos ( 2 {φ}_{i} ) )}^{2} + {( {\sum }_{i}^{N} sin ( 2 {φ}_{i} ) )}^{2}}$$

$$α = 1 / 2 arctan ( \frac{{\sum }_{i}^{N} sin ( 2 {φ}_{i} )}{{\sum }_{i}^{N} cos ( 2 {φ}_{i} )} )$$

Based on S11, one can numerically plot the SHG polar patterns of monolayer MoS₂ (N=1) and two BM-MoS₂ thin films (N=16 and 160) with 16 and 160 randomly generated φᵢ ranging from 0 to π (FIG. 9). The polar plot of the BM-MoS₂ thin film (red and blue curves in FIG. 9) shows six petals, consistent with experimental results shown in FIG. 3C as described above. While the depolarization effect enhanced with the increase of the number of MoS₂ flakes that contributed to the collected SHG signal.

### Note 3: SHG Modeling

SHG originates from the second-order nonlinear polarization induced by the electric field of the fundamental wave, which can be described as

$${P}_{j}^{NL} = {ε}_{0} {{χ}^{( 2 )} ( {E}_{j}^{( 1 )} )}^{2} exp ( - i 2 ω t ) \qquad ( S12 )$$

where P_{jNL, ε0}, χ⁽²⁾, Eⱼ(1), and ω denote the second-order nonlinear polarization of the jₜₕ layer of MoS₂ (as marked in FIG. 5A), vacuum permittivity, second-order susceptibility of Monolayer MoS₂, electric field of the fundamental wave in the jₜₕ layer of MoS₂, and the angular frequency of the fundamental wave, respectively. Next, the SH field (Eⱼ₍₂₎) and P_{jNL} are related in a wave equation as below

$${∇}^{2} {E}_{j}^{( 2 )} + {k}_{1}^{( 2 )} {E}_{j}^{( 2 )} = μ \frac{{\partial }^{2} {P}_{j}^{NL}}{\partial {t}^{2}} \qquad ( S13 )$$

where u denote magnetic permeability. k_{1(2)=2πn1(2)/λ2ω} is the wavevector of the SH wave in MoS₂, where λ_{2ω} and n₁₍₂₎ are the SH wavelength and refractive index of monolayer MoS₂ at this wavelength, respectively. To calculate the SH field, one first needs to calculate the fundamental field at each unit cells of the whole superlattice structure. Since the reflected field amplitude (E₀−) of the fundamental wave is already calculated from S10, the relative amplitude of the fundamental wave in each MoS₂ layer can be derived as

$$( \begin{matrix}{E}_{j}^{+} \\ {E}_{j}^{-}\end{matrix} ) = {{D}_{1}^{- 1} ( {D}_{2} {P}_{2} {D}_{2}^{- 1} {D}_{1} {P}_{1} {D}_{1}^{- 1} )}^{j - 1} {D}_{0} ( \begin{matrix}{E}_{0}^{+} \\ {E}_{0}^{-}\end{matrix} ) \qquad ( S14 )$$

where Eⱼ+ and Eⱼ− denote the amplitude of fundamental wave just across the PVP/MoS₂ interface in the jₜₕ layer of MoS₂ propagating forward and backward, respectively. Thus, the overall field intensity is obtained as |Eⱼ+|²+|Eⱼ−|², which gives the distribution of the fundamental filed intensity across the whole superlattice, as shown in FIG. 4b. Finally, followed by the derivation steps in Li, J.-J.; Li, Z.-Y.; Zhang, D.-Z., Second harmonic generation in one-dimensional nonlinear photonic crystals solved by the transfer matrix method. Physical Review E 2007, 75, 056606, one can solve the SH fields (E_{r,2ω}) radiated from the BM-MoS₂ thin film top surface and SH fields transmitted into the silver substrate (E_{t,2ω}) from the equation

$$( \begin{matrix}{E}_{r , 2 ω} \\ 0\end{matrix} ) = {G}_{Ag}^{- 1} {G}_{3} {Q}_{3} {G}_{3}^{- 1} {S}^{N} {G}_{3} ( \begin{matrix}0 \\ {E}_{r , 2 ω}\end{matrix} ) + {\sum }_{j}^{N} {G}_{0}^{- 1} {G}_{3} {Q}_{3} {G}_{3}^{- 1} [ ( {N}_{2} {B}_{1} {F}_{1} - {SB}_{1} ) ] ( \begin{matrix}{A}_{1} {E}_{j}^{+ 2} \\ {A}_{1} {E}_{j}^{- 2}\end{matrix} ) + ( {N}_{2} - S ) ( \begin{matrix}1 \\ 0\end{matrix} ) {C}_{1} {E}_{j}^{+} {E}_{j}^{-} ] \qquad ( S15 )$$

where G₀, G₁, G₂ G₃, Q₁, Q₂, Q₂, S, N₂, A₁, B₁, C₁, F₁ are defined as below

$${G}_{0} = ( \begin{matrix}1 & 1 \\ {n}_{0}^{( 2 )} & - {n}_{0}^{( 2 )}\end{matrix} ) \qquad ( S16 )$$

$${G}_{Ag} = ( \begin{matrix}1 & 1 \\ {n}_{Ag}^{( 2 )} & - {n}_{Ag}^{( 2 )}\end{matrix} ) \qquad ( S17 )$$

$${G}_{1} = ( \begin{matrix}1 & 1 \\ {n}_{1}^{( 2 )} & - {n}_{1}^{( 2 )}\end{matrix} ) \qquad ( S18 )$$

$${G}_{2} = ( \begin{matrix}1 & 1 \\ {n}_{2}^{( 2 )} & - {n}_{2}^{( 2 )}\end{matrix} ) \qquad ( S19 )$$

$${G}_{3} = ( \begin{matrix}1 & 1 \\ {n}_{3}^{( 2 )} & - {n}_{3}^{( 2 )}\end{matrix} ) \qquad ( S20 )$$

$${Q}_{1} = ( \begin{matrix}( exp ( {ik}_{1}^{( 2 )} {d}_{1} ) & 0 \\ 0 & ( exp ( - {ik}_{1}^{( 2 )} {d}_{1} )\end{matrix} ) \qquad ( S21 )$$

$${Q}_{2} = ( \begin{matrix}( exp ( {ik}_{2}^{( 2 )} {d}_{2} ) & 0 \\ 0 & ( exp ( - {ik}_{2}^{( 2 )} {d}_{2} )\end{matrix} ) \qquad ( S22 )$$

$${Q}_{3} = ( \begin{matrix}( exp ( {ik}_{3}^{( 2 )} {d}_{3} ) & 0 \\ 0 & ( exp ( - {ik}_{3}^{( 2 )} {d}_{3} )\end{matrix} ) \qquad ( S23 )$$

$$S = {G}_{2} {Q}_{2} {G}_{2}^{- 1} {G}_{1} {Q}_{1} {G}_{1}^{- 1} \qquad ( S24 )$$

$${N}_{2} = {G}_{2} {Q}_{2} {G}_{2}^{- 1} \qquad ( S25 )$$

$${A}_{1} = \frac{- 4 {με}_{0} {χ}^{( 2 )} {ω}^{2}}{{k}_{1}^{( 2 ) 2} - 4 {k}_{1}^{( 1 ) 2}} \qquad ( S26 )$$

$${B}_{1} = ( \begin{matrix}1 & 1 \\ {n}_{1}^{( 2 )} & - {n}_{1}^{( 2 )}\end{matrix} ) \qquad ( S27 )$$

$${C}_{1} = \frac{- 4 {με}_{0} {χ}^{( 2 )} {ω}^{2}}{{k}_{1}^{( 2 ) 2}} \qquad ( S28 )$$

$${F}_{1} = ( \begin{matrix}( exp ( {ik}_{1}^{( 1 )} {d}_{1} ) & 0 \\ 0 & ( exp ( - {ik}_{1}^{( 1 )} {d}_{1} )\end{matrix} ) \qquad ( S29 )$$

where n0(2), nAg(2), n1(2), n2(2), n3(2), n1(1), k1(2), k2(2), k3(2) are refractive index at SH wavelength of air, silver, monolayer MoS₂, PVP, alumina, refractive index at fundamental wavelength of monolayer MoS₂, and the corresponding wavevector at SH wavelength of monolayer MoS₂, PVP, alumina, respectively. In this calculation, chosen was n0(2)=1; nAg(2)=0.05+1.98i; n1(1)=4.26+0.09i; n1(2)=2.61+3.65i. Hence, directly obtained was the emitted SH fields (E_{r,2ω}) as a function of the superlattice thickness, as shown in FIG. 4A described above. Moreover, the transfer matrix approach allows not only the calculation of radiated SH wave but also the distribution of the SH intensity across the superlattice. With the as calculated E_{r,2ω}, one can use the equation below to solve the relative amplitude of the SH field in each MoS₂ layer

$$( \begin{matrix}{E}_{j , 2 ω}^{+} \\ {E}_{j , 2 ω}^{-}\end{matrix} ) = {S}^{j} {G}_{0} ( \begin{matrix}0 \\ {E}_{r , 2 ω}\end{matrix} ) + {\sum }_{m}^{j} {G}_{Ag}^{- 1} {G}_{3} {Q}_{3} {G}_{3}^{- 1} [ ( {N}_{2} {B}_{1} {F}_{1} - {SB}_{1} ) ] ( \begin{matrix}{A}_{1} {E}_{m}^{+ 2} \\ {A}_{1} {E}_{m}^{- 2}\end{matrix} ) + ( {N}_{2} - S ) ( \begin{matrix}1 \\ 0\end{matrix} ) {C}_{1} {E}_{m}^{+} {E}_{m}^{-} ] \qquad ( S30 )$$

where E_{j,2ω}+(−) denotes the electric field amplitude of the SH wave propagating forward (back ward) in the jₜₕ MoS₂ layer, and the overall SH field intensity is obtained as |E_{j,2ω}+|²+|E_{j,2ω}−|². Therefore, a distribution of the SH field intensity can be calculated, as shown in FIG. 4C above.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

Although the present embodiments have been particularly described with reference to preferred examples thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. A thin film material for highly efficient second harmonic generation (SHG) comprising:
alternating layers of monolayer MoS₂ separated by organic molecular layers.

2. The thin film material of claim 1, wherein organic molecular layers are configured to isolate interlayer coupling of MoS₂ between monolayers.

3. The thin film material of claim 2, wherein the isolation preserves monolayer-like non-linear optic (NLO) properties of the thin film material.

4. The thin film material of claim 1, wherein the organic molecular layers comprise organic ligands.

5. The thin film material of claim 1, wherein the organic molecular layers comprise PVP.

6. A method of preparing a thin film material for highly efficient second harmonic generation (SHG), comprising:
preparing a monolayer MoS₂ ink using an exfoliation and separation process;
dispersing in isopropanol (IPA) to formulate a stable ink material;
spraying the stable ink material onto a selected substrate to form a large-area continuous BM-MoS₂ thin film; and
stacking the PVP-capped MoS₂ monolayers vertically to form a superlattice thin film.

7. The method of claim 6, wherein preparing the monolayer MoS₂ ink is performed using an exfoliation and separation process.

8. The method of claim 7, wherein the exfoliation and separation process is followed by binding the MoS₂ with organic ligands.

9. The method of claim 8, wherein the organic ligands comprise PVP.
